(19) United States
(12) Patent Application Publication
(10) Pub. No.: US 2007/0294154 A1
(43) Pub. Date: Dec. 20, 2007

(54) Financial recommendation method for a business entity

(75) Inventor: Mark A. Henninger, Metamora, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 11/453,903

(22) Filed: Jun. 16, 2006

(51) Int. Cl. G06Q 40/00

(52) U.S. Cl. 705/35

(57) ABSTRACT

A method of providing a financial recommendation for a business entity includes providing a first set of constraints for a first set of financial categories having at least two spending categories. Predicted values for each of a plurality of financial categories that include at least the first set of financial categories are provided for at least a portion of a business cycle. The predicted values provided satisfy the respective first set of constraints. Based on at least one of the predicted values, at least one financial indicator value associated with at least one period of the business cycle is calculated. If the at least one financial indicator value satisfies the at least one desired financial rating for at least the portion of the business cycle, then at least one of the predicted spending values is provided as a first set of recommended future spending values.

### TECHNICAL FIELD

The present disclosure relates generally to a financial recommendation method, and more particularly, to a financial recommendation method for a business entity.

### BACKGROUND

In today's market, companies and other business entities often compete for investors and lenders. To improve their prospects, business entities seek to achieve high credit ratings and maximize shareholder return. Ratings and returns may be determined based on an analysis of a number of financial ratios and other financial indicators. Business entities often forecast future financial health to convince investors that the business entities will continue to prosper over a number of years. These forecasts typically focus on financial categories related to expected financial outputs, such as cash flows, assets, revenues, and profits. Investors may prefer to invest in business entities with strong future economic forecasts.

One method of forecasting the future financial strength of a business entity is described in U.S. Patent Application Publication No. 2003/0074211 A1, to LUN, published on Apr. 17, 2003. The '211 publication describes an online business planning system that creates a business plan for a corporation. The system generates web pages that ask a user to input certain data related to future financial categories. As a result of the input, the system generates a proposed financial outlook and proposes a corporate plan report. The report includes forecast assets, debts and equity, liabilities, revenues and profits, and cash flows.

Although helpful to investors and useful for general business planning, existing business forecast systems, such as the one taught by the '211 publication, fail to account for business entity spending that affects daily operations of the business entity. Instead, these systems only analyze and forecast general categories that indicate the general financial strength of the business entity, such as debt, cash flow, funds from operations, etc. However, additional categories, particularly related to business entity spending, also affect the future financial health of a business entity. For example, future dividend payments to stockholders, stock share repurchase spending, pension payments to former employees, and spending on investments, mergers, and acquisitions, all affect the future health of the business entity. The prior business forecast systems fail to analyze, forecast, or view these categories together with more general financial categories, such as revenues, profits, etc. As a result, the prior systems do not provide adequate analyses and recommendations related to future business expectations.

The disclosed methods and data structures are directed to overcoming one or more of the problems set forth above.

### SUMMARY OF THE INVENTION

In one aspect, the present disclosure is directed to a method of providing a financial recommendation for a business entity. The method includes providing a first set of constraints for a first set of financial categories. The first set of financial categories include at least two spending categories. The method additionally provides predicted values for each of a plurality of financial categories for at least a portion of a business cycle. The plurality of financial categories include at least the first set of financial categories, and the predicted values provided for the first set of financial categories satisfy the respective first set of constraints. Based on at least one of the predicted values, at least one financial indicator value associated with at least one period of the business cycle is calculated. The method determines whether the at least one financial indicator value satisfies at least one desired financial rating for at least the portion of the business cycle. If the at least one financial indicator value satisfies the at least one desired financial rating, then the method provides at least one of the predicted spending values as a first set of recommended future spending values.

In another aspect, the present disclosure is directed to a computer system for providing a recommendation for a business entity. The computer system includes a storage for storing data reflecting a first set of predicted values including predicted values for each of a plurality of financial categories for at least a portion of a business cycle. The categories include at least two spending categories, and the predicted values for the spending categories satisfy a first set of constraints. The computer system includes a module for calculating at least one financial indicator value associated with at least one period of the business cycle, based on at least one of the predicted values from the first set of predicted values. The computer system further includes a module for calculating an expected shareholder return for at least a portion of the business cycle, based on at least one of the predicted values from the first set of predicted values, and a module for determining whether the at least one financial indicator value satisfies at least one desired financial rating. The computer system also includes a module for providing at least one of the predicted spending values as a recommended future spending value, if the at least one financial indicator value satisfies the desired financial rating and the expected shareholder return is maximized.

In another aspect, the present disclosure is directed to a method of providing a financial recommendation for a business entity. The method includes providing predicted values for each of a plurality of financial categories for each period of a business cycle to create a first set of predicted values reflecting a first scenario. The plurality of financial categories include at least two spending categories. The method further provides one or more additional sets of predicted values for the plurality of financial categories for each period of the business cycle. The one or more additional sets reflect one or more respective additional scenarios. Based on at least part of the first set of predicted values, the method provides predicted spending values from the first set of predicted values as a first set of recommended future spending values. In addition, based on at least part of the one or more additional sets of predicted values, the method provides predicted spending values from one or more of the additional sets of predicted values as one or more additional sets of recommended future spending values. Then, based on at least the probability of the first scenario, the probabilities of the one or more additional scenarios, the first set of recommended future spending values, and the one or more additional sets of recommended future spending values, the method determines an optimum set of future spending values. The method then provides the optimum set of future spending values as a recommended set of future spending values.

### BRIEF DESCRIPTION OF THE DRAWINGS

FIG. 1 is an illustration of an exemplary system consistent with certain disclosed embodiments;

FIGS. 2a and 2b are illustrations of a data structures consistent with certain disclosed embodiments;

FIG. 3 is an illustration of a data structure consistent with certain disclosed embodiments; and

FIG. 4 is a flow chart illustrating an exemplary method consistent with certain disclosed embodiments.

FIG. 5 is a flow chart illustrating an exemplary method consistent with certain disclosed embodiments.

### DETAILED DESCRIPTION

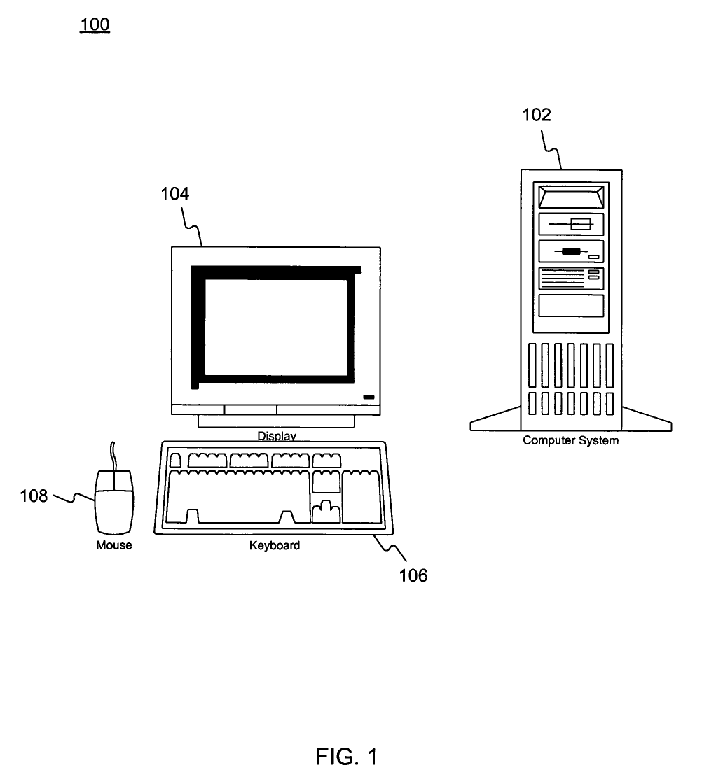

FIG. 1 illustrates an exemplary system 100 consistent with certain disclosed embodiments. System 100 may include a computer system 102, a display device 104, and input devices 106 and 108. System 100 may also include additional components (not shown), such as a printer, network interface, CD ROM drive, etc. Computer system 102 may be one or more computer devices known in the art, such as a microprocessor, laptop computer, pda, desktop computer, workstation, mainframe, distributed network computer system, etc., that may include hardware, firmware, and/or software (e.g., CPU, storage memory, operating system software, application software, etc.), for implementing one or more of the disclosed embodiments. For example, computer system 102 may include computer software modules (e.g., application programs, macros, formulas, etc.) that automatically and/or based on user input perform one or more calculations, determinations, analyses, etc., of the disclosed embodiments. Computer system 102 may be connected to and/or accessible from a network, such as the Internet, employing one or more network-based communication platforms, such as the World Wide Web. Display device 104 may be a computer screen or other device that permits a user to view displayed information, such as a projector device, a printer system, or other viewable display. Input devices 106 and 108 may be a computer keyboard 106 and mouse 108, and may also be any known input device or devices, such as a touch screen, a voice activated input device, or other device that allows information to be provided to computer system 102. Although FIG. 1 depicts a computer system 102 as separate from devices 104, 106, and 108, computer system 102 may be combined with any of devices 104, 106, 108, or other devices as a single unit. In addition, although FIG. 1 depicts a computer-based system, certain disclosed embodiments may also be implemented without a computer system. For example, in one embodiment, a pen and paper may be used to implement the disclosed financial recommendation method.

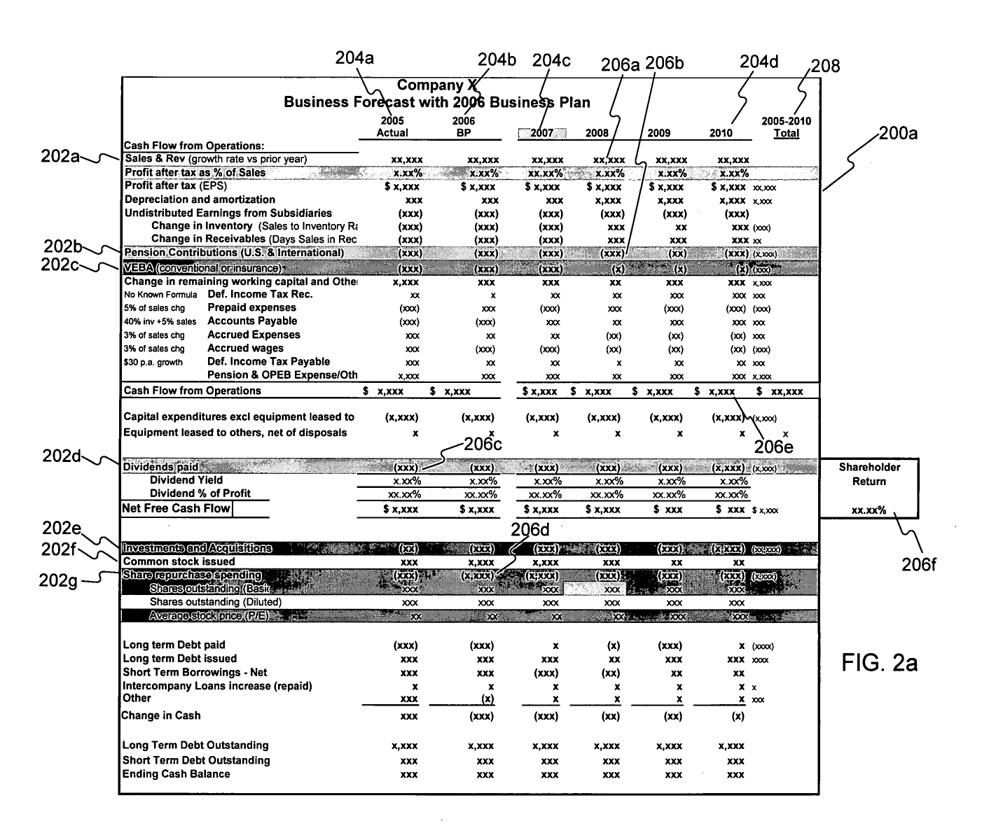

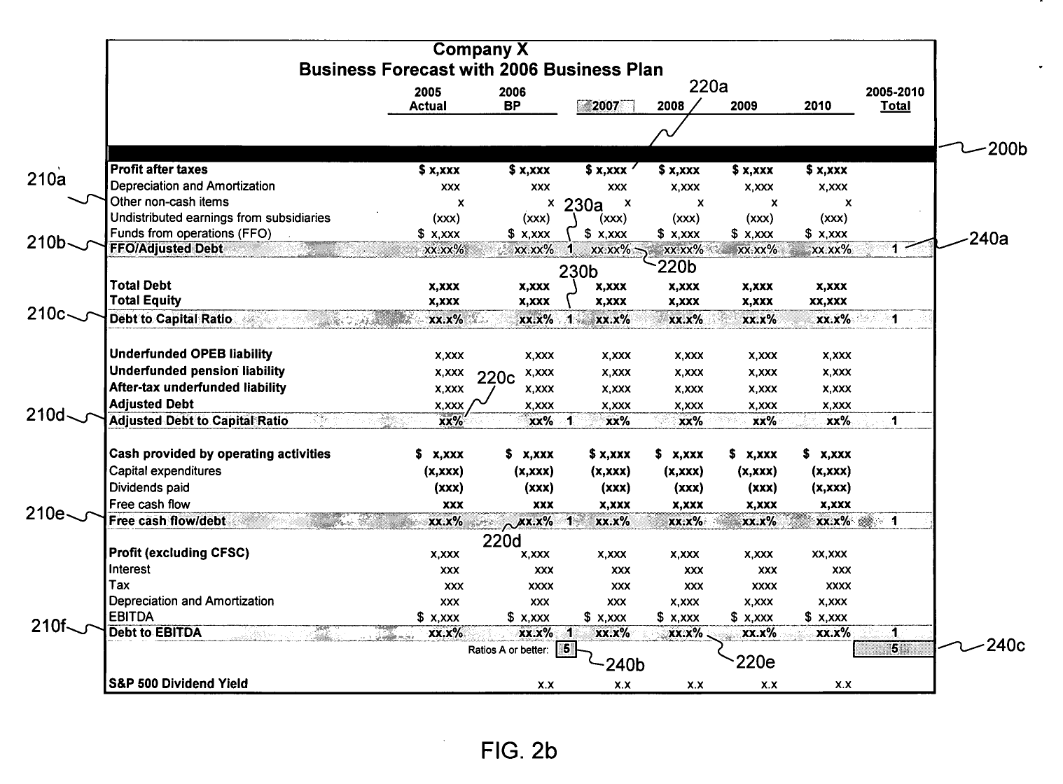

FIGS. 2a and 2b illustrate exemplary data structures consistent with certain disclosed embodiments. For example, FIG. 2a depicts a data structure 200a, having a number of rows and columns in table form and including a set of provided values. Data structure 200a displays information related to financial operations of a business entity (e.g., “Company X”) for a particular time span. A business entity may be a company, corporation, partnership, sole proprietorship, governmental agency, educational institution, non-profit organization, or any other entity that conducts business. Data structure 200a may be implemented using software on system 100, such as a spreadsheet application computer program, or it may be implemented using other mechanisms, such as pen and paper, a typewriter, a word processor computer program, etc. Although data structure 200a is shown as a table in row and column format, other formats may be used. Accordingly, the disclosed embodiments are not limited to the exemplary format shown in FIGS. 2a and 2b.

In one embodiment, data structure 200a may include one or more rows of data, each reflecting a financial category related to the business of the business entity. The financial categories may relate to spending, debt, revenue, profit, taxes, etc. For example, row 202a may include information related to sales and revenue for the business entity, row 202b may include information related to pension contributions made by the business entity, row 202c may include information related to business entity spending for Voluntary Employee Beneficiary Association/Medical Expense Plans (VEBA), row 202d may include information related to dividends paid by the business entity, row 202e may include information related to business entity spending for investments and acquisitions, row 202f may include information related to common stock issued by the business entity, and row 202g may include information related to stock share repurchase spending by the business entity. In one embodiment, additional rows and/or entry areas not shown in data structure 200a include additional information, such as dividend growth, for example. In one embodiment, VEBA spending may be considered a subset of pension contributions. The financial categories such as pension contributions, VEBA spending, dividends paid, investment and acquisition spending, stock repurchase spending, dividend growth and other categories relating to a business entity's spending of its cash, may be referred to as spending categories.

The financial categories included in data structure 200a are not limited to those described above, and may include additional or fewer categories related to the business entity. For example, in one embodiment, data structure 200a includes additional financial categories such as profit after tax, depreciation and amortization, undistributed earnings from subsidiaries, cash flow from operations, capital expenditures, net free cash flow, long term debt paid, long term debt issued, net short term borrowings, change in cash, long term debt outstanding, short term debt outstanding, ending cash balance, change in stock price, dividend payout ratio, average stock price, stock price per earnings ratio, dividend yield, shares outstanding, and/or any combination of categories. Financial categories may include any of the categories illustrated in FIG. 2a, may include fewer than the listed categories, or may include additional categories not illustrated in FIG. 2a. In one embodiment, a number of the financial categories in data structure 200a are spending categories, and a number are additional, non-spending financial categories (e.g., profit after tax, depreciation and amortization, etc.).

In one embodiment, data structure 200a includes columns that relate to periods of time related to the business entity. For example, column 204a may include business entity information related to a first period of time (e.g., 2005), column 204b may include information related to a second period of time (e.g., 2006), column 204c may include information related to a third period of time (e.g., 2007), and column 204d may include information related to a fourth period of time (e.g., 2010), etc. The columns may relate to other periods of time as well, such as days, weeks, months, groups of months, etc. Each column, and hence, each period of time represented by the column, may be referred to as a period. The columns may represent actual past periods (e.g., Year 2005 in column 204a), current periods (e.g., Year 2006 in column 204b), or future periods (e.g. Year 2007 in column 204c, etc.). A group of consecutive columns representing a group of consecutive periods may be referred to as a business cycle. For example, a business cycle in data structure 200a may include years 2005-2007, or may include years 2005-2010. A business cycle may also include only a single period (e.g., column 204c, for year 2007).

For each category in each period depicted in data structure 200a, a value may be provided. The value may reflect a monetary value (e.g., a positive or negative dollar amount), a percentage value, or other numerical or descriptive value. A value may be associated with an actual value for a past period, or a predicted value for a current or future period. For example, in data structure 200a, value 206a represents a predicted value for sales and revenue for Company X during future year 2008, value 206b represents a predicted value for pension contributions to be paid by Company X during future year 2008, value 206c represents an actual value for dividends paid by Company X during past year 2005, value 206d represents a predicted value for expected share repurchase spending by Company X for current year 2006, and value 206e represents a predicted value for cash flow from operations of Company X during future year 2009.

Some of the values provided to data structure 200a may depend on other provided values. For example, predicted value 206e representing predicted cash flow from operations in 2009 may be calculated as a sum of a number of other predicted values for year 2009. Similarly, the predicted values in column 208 (“2005-2010 Total”) for each specific financial category may be a calculated value based on the sum of the values for that category over a number of periods, such as 6 one-year periods of a six-year business cycle. In embodiments where data structure 200a is implemented with computer program software, data structure 200a may include additional displayed or hidden rows and/or columns that contain additional information. For example, additional rows and/or columns may contain delta information related to changes in certain predicted values between consecutive periods.

In one embodiment, data structure 200a includes additional rows, columns, and/or entry areas that include additional information. For example, data structure 200a may include additional entry areas that contain formulas, values, and/or text that are referenced in other cells. In one embodiment, data structure 200a includes entry area 206f related to expected shareholder return. The expected shareholder return depends on certain other predicted values in data structure 200a. In one embodiment, expected shareholder return is calculated by adding an average of the predicted change in stock price for a number of years to the average dividend yield over the same time period. Other formulas or calculations may be used to determine expected shareholder return.

In one embodiment, an operator and/or computer sets certain constraints for values entered into data structure 200a. In one embodiment, these constraints are stored in data structure 200a or another data structure. The constraints limit the financial information that may be included in data structure 200a or other data structures. For example, in one embodiment, dividend yield may be constrained to remain within a narrow range for a particular number of periods (e.g., within 0.5% or 1% of an industry standard, such as the S&P 500, for a number of years, such as 3 years, 4 years, etc.). In another embodiment, dividends paid and/or dividend growth may be required to remain positive and increasing over a number of years. Other constraints that may be included in system 100 include dividend payout ratio over a number of periods (e.g. 10 years, 8 years, etc.) remaining within a particular range, cash balance remaining within a certain range for each period, shares outstanding reaching a particular level in a future year (e.g. X shares outstanding in 2008), minimum number of shares repurchased each period, minimum and maximum spending limits for pension contributions over a number of periods (e.g., 3 years, 5 years, etc.) or for any given period, etc. These constraints may be applied by computer code, macros, and/or instructions associated with data structure 200a (e.g., Microsoft Excel rules, etc.), and/or may be applied by human interaction (e.g., an analyst ensuring that the values comply with the constraints).

FIG. 2b depicts a data structure 200b having a number of rows and columns. Data structure 200b may include information related to financial operations of a business entity (e.g., Company X) for a particular time span (e.g., one or more periods, one or more business cycles, etc.). Data structure 200b may include one or more rows that each represent a financial category, and one or more columns that represent periods of time, similar to data structure 200a. Some of the financial categories in data structure 200b may be the same categories and may represent the same values as in data structure 200a. For example, the depreciation and amortization category 210a in data structure 200b may reflect the same category included in data structure 200a. Other financial categories in data structure 200b may be calculated based on one or more categories from data structure 200a, and may represent financial indicators that reflect the financial strength of the business entity. For example, the funds from operations to adjusted debt category 210b, the debt to capital ratio category 210c, the adjusted debt to capital ratio category 210d, the free cash flow to debt category 210e, and the debt to earnings before interest, taxes, depreciation, and amortization (EBITDA) category 210f may represent financial indicators related to the financial strength of the business entity. Other financial indicators may be included in data structure 200b, such as price to earnings ratio, earnings per share, and any other categories typically used by business analyst firms and/or credit rating agencies to assess a business entity's financial strength.

Each category for each period depicted in data structure 200b may be provided with a value. The value may reflect a monetary value (e.g., a positive or negative dollar amount), a percentage value, or other numerical or descriptive value. A value may be an actual value for a past period, or a predicted value for a current period or future period. Values for categories representing financial indicators may be referred to as financial indicator values. For example, in data structure 200b, value 220a represents a predicted value for profit after taxes for Company X during future year 2007, value 220b represents a predicted financial indicator value for a funds from operations (FFO) to adjusted debt ratio for Company X during future year 2007, value 220c represents an actual financial indicator value for an adjusted debt to capital ratio for Company X during past year 2005, value 220d represents a predicted financial indicator value for a free cash flow to debt ratio for Company X during current year 2006, and value 220e represents a predicted financial indicator value for a debt to EBITDA ratio for Company X during future year 2008.

Data structure 200b may additionally include an indication of financial ratings associated with one or more financial indicator values. These financial ratings may be presented in numerical (e.g., 1, 2, 3, 4, 5), alphabetical (e.g., A, B, C, D, F), or in other forms. In embodiments where data structure 200b is implemented with computer program software, the financial rating may be displayed or hidden. The financial ratings may be based on one or more of the financial indicator values discussed above, and may be determined based on one or more rule sets by internal business departments or external entities, such as financial analysis firms and/or credit rating agencies. For example, a financial rating 230a of “1” may correspond to an expected “A” rating from a credit rating agency for the predicted FFO to adjusted debt ratio for Company X during year 2006. Similarly, a financial rating 230b of “1” may correspond to an expected “A” rating from a credit rating agency for the predicted debt to capita ratio for Company X during year 2006. Data structure 200b may include financial ratings for each financial indicator value for each period, or it may include financial ratings for only a select number of financial indicator values for selected periods. These financial ratings may then be analyzed to determine whether the predicted values provided to data structure 200a will result in favorable future ratings by financial analysis firms and credit rating agencies.

In one embodiment, a number of individual financial ratings corresponding to a number of individual financial indicator values may be combined to determine an overall financial rating. For example, the financial rating 240a of “1” may reflect a summation of financial ratings for FFO to adjusted debt ratios for years 2005-2010. The financial rating 240b of “5” may reflect a summation of predicted financial ratings corresponding to different financial indicator values for year 2006. Financial rating 240c of “5” may reflect a summation of financial ratings for a number of different financial indicator values for the combined years 2005-2010.

In one embodiment, a number of expected financial ratings may be analyzed and compared to one or more desired financial ratings to determine whether the business entity will receive high credit ratings in the future from an external entity, such as a financial analyst firm and/or credit rating agency. In one embodiment, the analysis may determine an average expected financial rating over a number of financial categories and/or time periods, and may compare that average to a desired financial rating for the same financial categories and/or time periods. In another embodiment, the analysis may determine a number of individual expected financial ratings that achieve a particular desired rating for one or more time periods, and may then determine whether that number is above a particular threshold. Other techniques to analyze the financial rating of the business entity may be implemented.

As a non-limiting example, a business entity may analyze five financial indicator categories for each year of a future three year business cycle. Each category may have a different financial indicator value for each year, and each financial indicator value may be assigned an expected financial rating, such as A, B, C, D, or F. For example, categories 1-5 may have respective ratings of A, C, A, B, and A for the first year, A, A, A, A, and B for the second year, and A, A, A, A, F for the third year. In one embodiment, using an average expected financial rating analysis, the ratings may be analyzed to determine an average expected rating over all five categories for each year. Thus, the first year average may be a B+, the second year average may be an A, and the third year average may be a B. The averages for each year may then be compared to a desired average financial rating for those years (e.g., A− or better) to determine whether the business entity will achieve its desired financial rating for each year. In another embodiment, rather than using an average expected rating, the analysis may determine a number of financial indicator values for each year that will receive a score above a particular threshold (e.g. A− or better). For example, the analysis may assign a “1” for each financial indicator value expected to achieve an “A” rating, and may then sum the number of “1” indicators for each year. Thus, following by the above example, the first year would have three “1” indicators, and the second and third year would each have four “1” indicators. The analysis may also compare the number of “1” indicators for each year to a threshold number (e.g., four “1” indicators) to determine whether the business entity will achieve its desired financial rating for each year. In another embodiment, the analysis may average the number of “1” indicators per year for a span of years and compare that average number to a threshold number (e.g., average of three “1” indicators per year) to determine whether the business entity will achieve its desired financial rating for the span of years.

In one embodiment, a desired financial rating for the business entity will be satisfied if both a minimum of 80% (e.g., four of five) of the financial indicators achieve an expected “A” rating in a three year period, and a minimum of 60% (e.g., three of five) of the financial indicators achieve an expected “A” rating in any given year. Thus, for the three-year period of examples given above, the business entity fulfills the 60% “A” ratings for any given year, but would fail to fulfill the 80% “A” ratings for the three year period if both categories 2 and 5 fail to achieve an “A” rating for the three-year period. Other percentages and formulas may be used to determine whether a desired financial rating is satisfied.

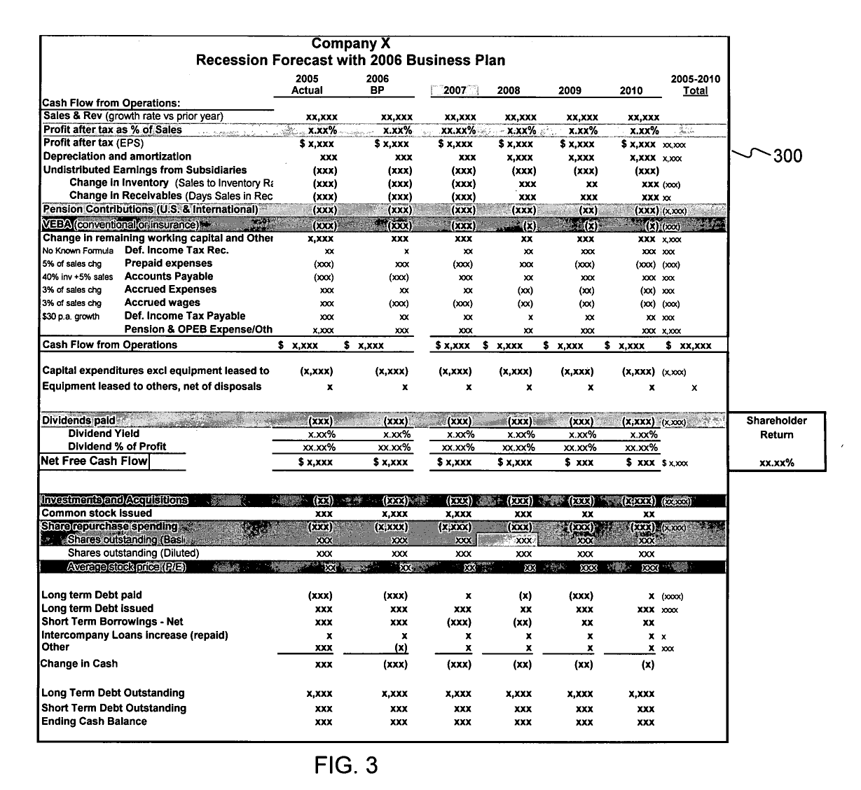

FIG. 3 illustrates an exemplary embodiment of an additional data structure 300 consistent with certain disclosed embodiments. Data structure 300, in one embodiment, includes the same financial categories and time periods as FIG. 2a. Data structure 300 may include a different set of values representing a different economic scenario as compared to the values provided to data structure 200a. In one embodiment, the values provided to data structure 200a reflect financial values indicative of a time span of economic growth, while the values provided to data structure 300 reflect financial values indicative of an economic recession. For example, as exemplarily depicted in data structure 200a, sales and revenue, cash flow from operations, and profit all progressively increase between the years of 2007 and 2010, indicating economic growth. However, the same financial categories in data structure 300 exhibit progressively decreasing values between the years of 2007 and 2010, indicating an economic recession. The same analysis described with respect to FIGS. 2a and 2b may be performed on the information provided in FIG. 3 and additional financial indicator and financial rating values not shown in FIG. 3. The analysis may indicate expected future financial ratings and/or expected shareholder return values for a different set of predicted values for the same financial categories. In one embodiment, system 100 includes additional data structures representing different economic scenarios (e.g., booming economic growth, medium economic growth, zero economic growth, etc.).

The data structures depicted in FIG. 2a, FIG. 2b, and FIG. 3, and any additional data structures included in system 100, may be combined to form a single data structure, or may be separate data structures. Further, the data structures in FIGS. 2a, 2b, and 3 may be stored as data in a storage device accessible by a computer system, such as computer system 102. In addition, the data structures depicted in FIGS. 2a, 2b, and 3 may include actual values for one or more past periods (e.g., 6 months, 3 years, 5 years, etc.) in addition to one or more future periods and/or a current period. In one embodiment, the values for past periods may be used to help predict future values. For example, values for past periods may be analyzed for trends that may help predict future values. Past periods may also be analyzed to verify that predicted future values are within a reasonable range of expectations. These analyses may be performed entirely or in part by a computer system, or may be performed manually, without the aid of a computer.

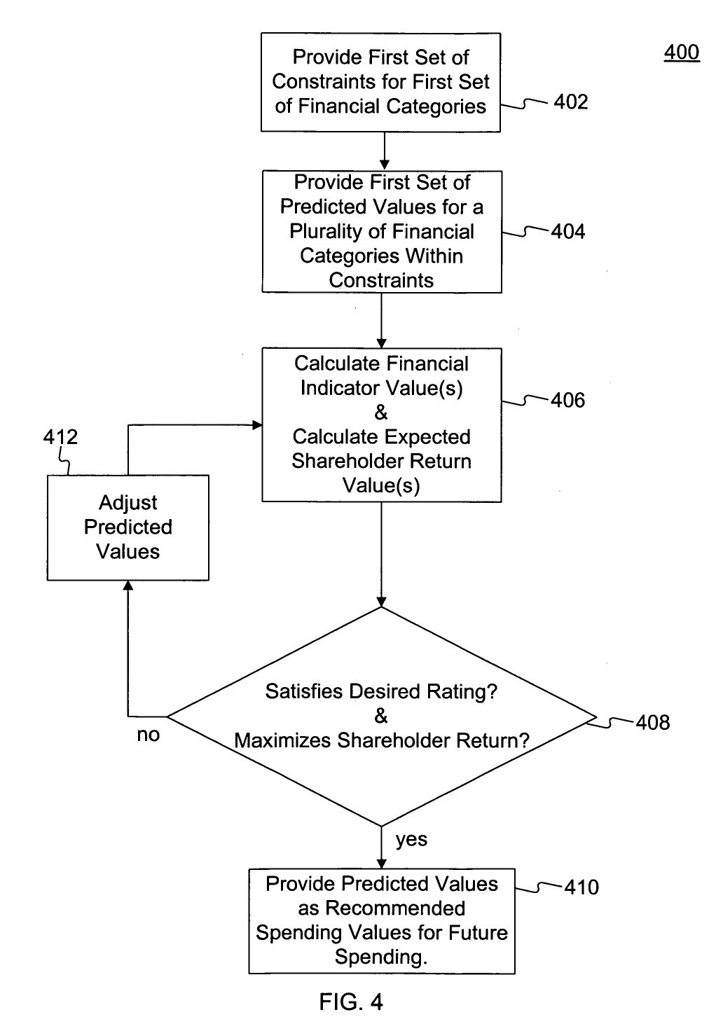

FIG. 4 illustrates an exemplary embodiment of a method 400 for providing recommended spending values consistent with certain disclosed embodiments. In step 402, a first set of constraints is provided for a first set of financial categories. The categories may include categories selected from the categories described in reference to FIG. 2a, and/or selected from additional categories not shown in FIG. 2a. These constraints impose limits on the financial information that may be provided to data structure 200a or other data structures (step 404). For example, in one embodiment, the provided constraints include limits on one or more of dividend yield, dividends paid, dividend growth, dividend payout ratio, cash balance, shares outstanding, shares repurchased, pension contributions, etc. Constraints on other categories may be imposed as well (e.g., VEBA payments, debt issued, or any other category).

The constraints may be applied by computer code, macros, and/or instructions associated with data structure 200a (e.g., Microsoft Excel rules, etc.), and/or may be applied by human interaction (e.g., an analyst ensuring that the values comply with the constraints). For example, in one embodiment that uses a computer program, the computer program may set limits on predicted values for certain categories. If a provided value exceeds the limits, the computer program may mark the value in a different color (e.g., red) to indicate that the value is outside of the constraints. In another example, the computer program may refuse to accept provided values if they fall outside of the constraints (e.g., the program may present a pop-up box asking a user to enter another value). In yet another embodiment, the computer program may allow provision of any value, but the predicted values may be limited manually by a user providing data. In an embodiment that does not use a computer, an analyst may limit provided values to remain within the set constraints, and/or may continuously check to ensure that no values fall outside of the constraints.

In step 404, a first set of predicted values is provided for a plurality of financial categories. In one embodiment, the provided values comply with any constraints set in step 402. These categories may include a combination of categories selected from the categories described in reference FIG. 2a, and/or selected from additional categories not shown in FIG. 2a. For example, in addition to the categories shown in FIG. 2a, predicted values may include dividend payout ratio, dividend growth, average stock price, change in stock price, expected shareholder return, etc. The predicted values may be provided from different independent or cooperating business units within a business entity, or may be provided from an external source (e.g., a different business entity, an online source, a contracted party, etc.). In one embodiment, the predicted values are provided from different parties within the business entity (e.g., different business units, different individual employees, etc.), and are determined based on independent analyses.

For example, in one embodiment, a management-level planning committee in a corporation may analyze market trends using appropriate software analysis tools to determine predicted values for a future business cycle for a number of financial categories related to cash flow from operations (e.g., sales and revenue, profit after tax, depreciation and amortization, undistributed earnings from financial products, change in remaining working capital, etc.). A member of the pensions and benefits unit within the corporation may separately analyze expected pension payments and VEBA contributions to determine corresponding predicted values for those categories for the same future business cycle. A mergers and acquisitions group may analyze expected investment and acquisition payments to determine predicted values for those categories for the same future business cycle. An additional committee, which, in one embodiment, may have access to another committee's analysis, may determine predicted values for stock repurchase spending and dividend payments for the same future business cycle based on its own analysis. Additional categories may be analyzed to determine appropriate predicted values.

The predicted values may be determined automatically or manually, by any combination of user analysis, computer software programs, and/or other financial analysis tools. In one embodiment, the predicted values may be provided to a computer application program, such as Microsoft Excel®, that permits the values to be stored, retrieved, edited, and displayed in a format that shows all of the predicted values on a single spreadsheet. The computer application program may be configured to allow further analysis, editing, etc., of the values. For example, certain values may be entered into the application program by a user (e.g., sales and revenue, pension contributions, etc.), while others may be calculated based on other values according to set formulas (e.g., cash flow from operations, ending cash balance, etc.), or imported from other application programs or files. In one embodiment, the predicted values may be provided on a sheet of paper (e.g., as printed from a computer program, typed using a typewriter, written using a pen or other writing implement, etc.). Displaying all of the categories together on a single spreadsheet or display permits a user or computer program to quickly and easily analyze the different categories and their relationships to each other.

In step 406, one or more of the provided predicted values may be used to calculate one or more financial indicator values. In one embodiment, one or more of the provided predicted values is also used to calculate one or more expected shareholder return values for one or more time periods. In one embodiment, the financial indicator values and/or expected shareholder return values are calculated and provided to a computer program (e.g., the same computer program storing the predicted values) that permits display, storage, and further analysis of the values. For example, in one embodiment, based on user-based calculations and/or computer-based calculations, certain financial indicator values (e.g., FFO to adjusted debt ratio, debt to capital ratio, adjusted debt to capital ratio, free cash flow to debt ratio, debt to EBITDA ratio, etc.) and expected shareholder return values are determined and are provided to a computer program (e.g., spreadsheet application) in a form similar to that shown in FIG. 2b. The values may be manually input into the spreadsheet and/or automatically provided via input from computer processes (e.g. formulas, macros, etc.).

In one embodiment, based on the calculated financial indicator values, corresponding expected financial ratings are determined. The ratings may be determined based on existing standards provided by credit rating agencies such as Moody's or Standard and Poor's. For example, a FFO to adjusted debt ratio of 40% may be listed on Moody's as an “A” rating, a debt to capital ratio of 30% may also be listed on Moody's as an “A” rating, etc. In another embodiment, the ratings may be determined based on expected future standards to be used by credit rating agencies. In one embodiment, a database or table of financial ratings and associated financial indicator values may be stored by a computer or other device. The database/table may then be accessed to determine expected financial ratings that correspond to respective predicted financial indicator values. For example, expected financial ratings for particular financial indicator values may be stored on stand-alone personal computer, on a printed paper chart, on a remote computer system over a computer network such as the Internet, etc. In one embodiment, the expected financial ratings may be stored in and/or obtained from a computer storage area associated with a computer program (e.g., Microsoft Excel) in computer system 102 to determine the ratings that correspond to the financial indicators calculated in step 406. Other mechanisms may be used to determine expected financial ratings for the one or more predicted financial indicator values.

In one embodiment, the financial ratings may be provided to a computer program (e.g. Microsoft Excel) capable of further analyzing the ratings. In one embodiment, the computer program may determine average expected financial ratings for a single financial category over a number of time periods (e.g., 6 one-month periods, 3 one-year periods, 6 one-year periods, etc.). The program may also determine average expected financial ratings for a group of combined financial categories for a single time-period (e.g., 2006, 2007, 2008, etc.). In another embodiment the program may determine average expected financial ratings for a group of combined financial categories over a number of time periods. A user may also determine the average values without computer programs.

The expected financial rating or ratings may then be further analyzed to determine whether they satisfy a desired financial rating (step 408). For example, in one embodiment, the expected financial ratings determined from their corresponding financial indicator values are analyzed to determine whether the financial indicator values will satisfy one or more desired financial ratings. In one embodiment, this step may include a comparison of each expected financial rating to a respective desired financial rating. For example, the expected financial rating corresponding to each respective financial indicator for the year 2007 may be compared to a desired financial rating, such as an “A” to determine which financial indicators and how many financial indicators are expected to receive an “A” rating in 2007. If, for example, that number or if the ratio of “A” ratings to “non-A” ratings is above a particular threshold (e.g., more than 5 “A” ratings; 80% of financial indicators expected to have “A” ratings), then the method would determine that the desired rating for that particular set of financial categories over that particular time period is satisfied. In another embodiment, step 408 may include analyzing expected average financial ratings to determine whether those ratings are above a particular threshold (e.g., determine whether the average financial rating for all financial indicators in 2007 is above an “A−” rating). If the average rating is above the threshold, then the desired rating for that particular set of financial categories over that particular time period is satisfied.

In one embodiment, a desired financial rating for the business entity will be satisfied if both a minimum of 80% (e.g., four of five) of the financial indicators achieve an expected “A” rating in a three year period, and a minimum of 60% (e.g., three of five) of the financial indicators achieve an expected “A” rating in any given year. Other analyses may be used to determine whether desired financial ratings will be achieved.

In one embodiment, step 408 additionally determines whether expected shareholder return is maximized within the constraints provided in step 402. Expected shareholder return may be calculated, for example, by adding an average of the predicted change in stock price for a number of years to the average dividend yield over the same time period. Other formulas or calculations may be used. To determine whether the expected shareholder return is maximized, an analysis may be performed that determines the shareholder return for a number of different sets of predicted values that comply with the constraints, and then determines which set provides the greatest expected return. In one embodiment, for example, a Monte Carlo simulation or regression analysis tool may be used to determine the maximum expected shareholder return. The analysis may be performed by a computer and/or by human calculations. Furthermore, although FIG. 4 depicts the steps of method 400 in a particular order, FIG. 4 is not intended to limit the steps of method 400 to the particular order shown. For example, in one embodiment where both the maximum shareholder return values and the financial indicator values are analyzed, the maximum shareholder return values may be determined before any financial indicator values are calculated or analyzed. In another embodiment, the a set of predicted values that achieve a maximum shareholder return may be initially determined. The set of predicted values may then be provided to a data structure and used to calculate financial indicator values. The financial indicator values can then be analyzed to determine whether they satisfy a desired rating. In yet another embodiment, the maximum shareholder return may be determined by an analysis tool that calculates maximum shareholder return while accounting for both the provided constraints and the desired financial rating. Other methods to determine maximum shareholder return may be used as well.

If the desired financial rating is satisfied and the expected shareholder return is maximized within the constraints (step 408, “yes”), then the method continues to step 410. If, however, the desired financial rating is not satisfied or expected shareholder return is not maximized within the constraints (step 408, “no”), then the method continues to step 412.

In step 410, some of the predicted values provided in step 402 may be recommended as expected values for future spending. These values may be provided to additional computer programs, to business entity employees or business units, or to any other person or entity. In one embodiment, for example, the predicted values for pension contributions, VEBA contributions, dividends paid, investments and acquisitions, and share repurchase spending may be provided to the business entity as recommended future spending values for the business entity. The values may be provided to display device 104 or to one or more other display devices, provided to one or more printers, provided electronically to one or more other computer programs and/or computer systems or users (e.g., via e-mail, fax, etc.), provided on paper, etc. The business entity can then plan for the future accordingly.

In step 412, some of the predicted values provided in step 404 may be adjusted to form an adjusted set of predicted values. For example, in one embodiment, one or more of the predicted values may be increased or decreased by a certain percentage or certain numerical value (e.g., increase share repurchase values 1% for each period; increase dividend payments by $ 10 million for one period, etc.). The adjusted set of predicted values may then be further analyzed by repeating to steps 406 and 408 for the adjusted set. In one embodiment, the predicted values may be adjusted in a priority order. For example, it may be desirable to adjust values for share repurchase spending or dividends paid before adjusting values for investment and acquisition spending, because investment and acquisition spending may have a greater impact on the business entity's growth. As another example, it may be desirable to adjust values for VEBA payments before adjusting values for overall pension payments, as pension payments may be more tightly regulated by the government and therefore less easily adjusted. However, any priority, or no priority, may be used, and the predicted values provided in step 404 may be adjusted in step 412 in any desired order. Furthermore, the predicted values may be adjusted at any time. For example, if the system at any time determines that a desired financial rating will not be satisfied, or determines that shareholder return will not be maximized, predicted values may be adjusted at that time. The predicted values may be adjusted for any other reason at any other time as well.

In one embodiment, certain spending values are adjusted according to the constraints provided in step 402, or according to other guidelines. For example, dividend payments may be adjusted to remain constant or to increase over a number of future periods in order to maintain shareholder confidence, but should not decrease from one period to the next. In another example, if certain financial indicators are undesirable (e.g., debt to capital ratio is too high), then particular financial categories (e.g., share repurchase spending) may be adjusted first (e.g., in order to increase the business entity's cash, thereby reducing the need to acquire debt). In yet another example, the predicted values may be adjusted in a way that maintains the business entity's surplus cash at a low, constant value. Although specific examples are described, any desirable constraints or guidelines for adjusting the predicted values may be used.

After the adjusted set of predicted values is provided (step 412), the method continues at step 406 by calculating an adjusted set of financial indicator values based on the adjusted set of predicted values. The method then uses this adjusted set of financial indicator values in step 406 to determine whether a desired financial rating corresponding to the adjusted set of financial indicator values will be satisfied, and whether the expected shareholder return will be maximized (step 408). Steps 406, 408, and 412 may be repeated any number of times, until the desired financial ratings are satisfied and the expected shareholder return is maximized.

Method 400 may be performed by humans, computer systems, and/or or other analysis tools (e.g., linear programming, neural networking, genetic algorithms, etc.). For example, in one embodiment, an analyst may first set constraints (step 402) and may then create a data structure with predicted values that comply with the constraints (step 404), such as illustrated in FIG. 2a. The data structure may be printed, typed, handwritten, etc., on paper and/or an electric medium. Next, the analyst may calculate the financial indicator values and expected shareholder return values (step 406) by hand or using a calculator, computer program, or other computing devices or tools. The analyst may then obtain a paper or electronic document (e.g., a book, online web page, computer printout, etc.) that indicates expected financial ratings for particular financial indicator values, and may use the document to determine whether the calculated financial indicator values satisfy the desired financial ratings (step 408). The analyst may then perform multiple iterations of steps 402, 404, and 406 to determine a maximum shareholder return value under the given constraints that still satisfies the desired financial ratings. If the desired financial ratings are satisfied and the maximum shareholder return value under the constraints is achieved (step 408), the analyst may deliver the data structure (e.g., by hand delivery, postal mail, e-mail, etc.) to another employee of the business entity as a recommendation for future spending (step 410). If not, the analyst may perform the iterative process described in steps 412, 406, and 408 of method 400.

In another embodiment, a computer (e.g., computer system 102) may have constraints set (402) and may automatically determine the first set of predicted values (step 404) based on the constraints and other information obtained from computer programs or processes. For example, a software application file may be programmed to automatically retrieve the predicted values from other software application files that contain predicted values. The computer may then automatically calculate the financial indicator values (step 406), and calculate expected shareholder return according to stored formulas, macros, etc. The computer may obtain expected financial ratings for particular financial indicators by querying a database or other data structure (e.g., a local database stored on the computer, a remote database located on the Internet, etc.), and may automatically determine whether the calculated financial indicator values satisfy the desired financial ratings (step 408). The computer may further execute one or more computer software applications or analysis tools (e.g., Microsoft Excel, Monte Carlo simulations, neural networking tools, regression analysis, optimization software, etc.) to determine a maximum shareholder return within the constraints, and may use this result to determine if the expected shareholder return is maximized (step 408). If the desired financial ratings are satisfied and the expected shareholder return is maximized, the computer may automatically print a future spending recommendation report, provide the report electronically (e.g., fax, e-mail, text message, computer program file, etc.) or may provide the recommended spending values to one or more additional computer programs for further analysis (step 410). If the desired financial ratings are not satisfied or the shareholder return is not maximized, the computer may automatically adjust predicted values to create an adjusted set of predicted values. The adjustment may depend on one or more rules (e.g., constraints, guidelines, statistical theories, etc.) set by a computer program, an analyst, regression analysis tools, neural networking software, etc. The computer may then run the iterative process described in steps 412, 406, and 408 (e.g., using optimization software) until a desired financial rating and maximum shareholder return are satisfied. The maximized values may then be recommended as future spending values.

In yet another embodiment, method 400 may be implemented by a combination of human and computer interaction. For example, in one embodiment, an analyst may enter the first set of predicted values according to set constraints, and then the computer may perform the remainder of method 400 automatically. In another embodiment, an analyst may enter the first set of predicted values and the adjusted set(s) of predicted values, and the computer may check that the values comply with the restraints and perform the remainder of method 400 automatically. Accordingly, any combination of human and computer interaction may be used to implement method 400.

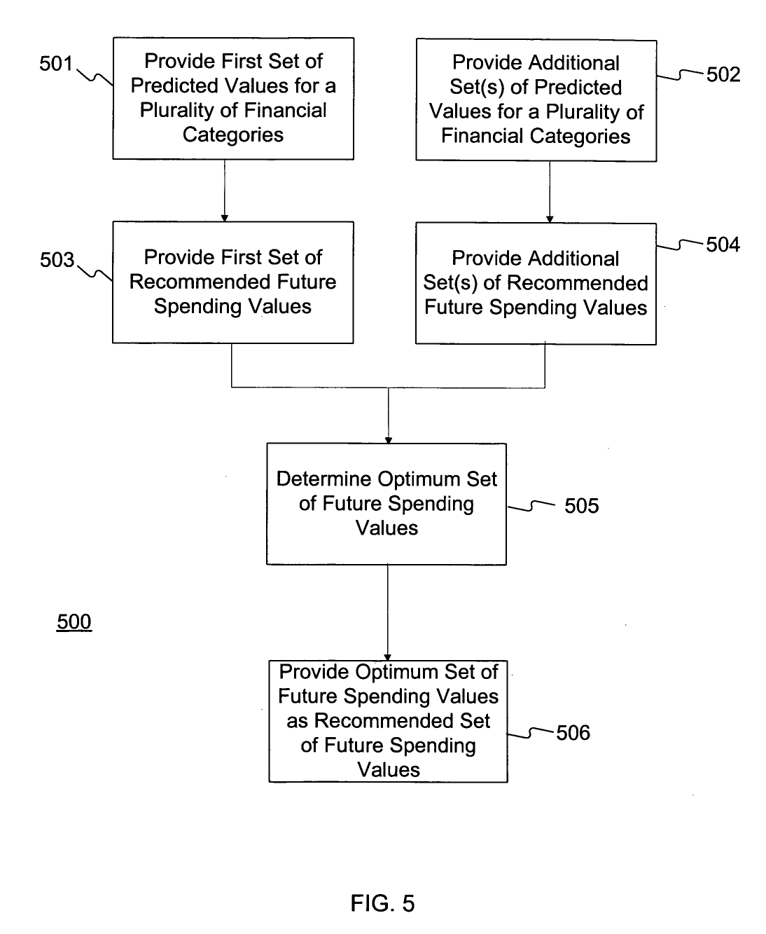

In one embodiment, method 400 is separately performed for two or more separate sets of predicted values, as depicted in FIG. 5. For example, a first set of predicted values may be provided (step 501) that corresponds to a first scenario (e.g., an expected period of economic growth, such as shown in FIG. 2a). Based on these predicted values, and using a method such as method 400, a first set of recommended future spending values may be provided (step 503). Additional sets of predicted values may also be provided (step 502) that correspond to additional scenarios (e.g., an expected period of economic recession, an expected period of booming economic growth, an expected period of zero economic growth, etc.). Based on each of these sets of predicted values, and using a method such as method 400, additional sets of recommended future spending values may be provided (step 504). Based on the first set of recommended future spending values and any additional sets of recommended future spending values, an optimum set of fuiture spending values can be determined (step 505).

The optimum set may be determined based on the probability of the one or more of the provided scenarios occurring, the risk involved in selecting the predicted values of the scenarios, and/or other factors. The optimum set may be determined by analysis tools (e.g., computer optimization software), and/or by human analysis (e.g., a visual comparison of the different scenarios). In one embodiment, only scenarios having a probability that exceeds a predetermined threshold are considered in determining the optimum set. Other methods may be used to determine the optimum set of future spending values. In step 506, the optimum set of fuiture spending values is provided as a recommended set of future spending values.

These values may be provided to additional computer programs, to business entity employees or business units, or to any other person or entity. In one embodiment, for example, the predicted values for pension contributions, VEBA contributions, dividends paid, investments and acquisitions, and share repurchase spending may be provided to the business entity as recommended future spending values for the business entity. The values may be provided to display device 104 or to one or more other display devices, provided to one or more printers, provided electronically to one or more other computer programs and/or computer systems or users (e.g., via e-mail, fax, etc.), provided on paper, etc. The business entity can then plan for the future accordingly.

### INDUSTRIAL APPLICABILITY

The disclosed method of making a financial recommendation may be applicable to any business entity that analyzes its financial status. For example, a multi-national corporation may use the method to develop a future business plan. The corporation may analyze a number of predicted future spending values in order to develop an optimal business plan resulting in high credit ratings. For example, the corporation may adjust future spending categories such as pension contributions, VEBA spending, investment and acquisition spending, and share repurchase spending to achieve an optimal credit rating. The method may also be used by individuals or smaller companies, startup corporations, governmental agencies, or any other business entities seeking to achieve optimal financial growth. Any device may be used to implement the disclosed method. For example, the disclosed data structures may be stored, adjusted, and displayed on a PC or other computer system running software such as Microsoft Excel. The data structures may also be stored, adjusted, and displayed on other media such as paper, a chalk board, etc.

Several advantages over the prior art may be associated with the disclosed method. For example, the disclosed method analyzes a number of spending categories, which provides the business entity with a more comprehensive business recommendation than traditional financial analyses. The disclosed method further provides business entities with a simple, efficient way to plan for desired future financial goals.

It will be apparent to those skilled in the art that various modifications and variations can be made to the method of making a financial recommendation. Other embodiments will be apparent to those skilled in the art from consideration of the specification and practice of the disclosed method. It is intended that the specification and examples be considered as exemplary only, with a true scope being indicated by the following claims and their equivalents.

What is claimed is:

1. A method of providing a financial recommendation for a business entity, comprising:
(a) providing a first set of constraints for a first set of financial categories, the first set of financial categories comprising at least two spending categories;
(b) providing predicted values for each of a plurality of financial categories for at least a portion of a business cycle, thereby creating a first set of predicted values, wherein the plurality of financial categories include at least the first set of financial categories, and wherein the predicted values provided for the first set of financial categories satisfy the respective first set of constraints;
(c) based on at least one of the predicted values from the first set of predicted values, calculating at least one financial indicator value associated with at least one period of the business cycle;
(d) determining whether the at least one financial indicator value satisfies at least one desired financial rating; and
(e) if the at least one financial indicator value satisfies the at least one desired financial rating, then providing at least one of the predicted spending values as a first set of recommended future spending values.

2. The method of claim 1, further including:
if the at least one financial indicator value does not satisfy the desired financial rating, then adjusting at least one of the predicted values associated with a spending category, to provide an adjusted set of predicted values; and
repeating steps (c) through (e) using the adjusted set of predicted values.

3. The method of claim 1, further including:
(f) based on at least one of the predicted values from the first set of predicted values, calculating an expected shareholder return for at least a portion of the business cycle;
(g) determining whether the expected shareholder return for the predicted values for at least the portion of the business cycle is maximized within the first set of constraints; and.
(h) if the at least one financial indicator value satisfies the at least one desired financial rating and the expected shareholder return is maximized within the first set of constraints, then providing at least one of the predicted spending values as a first set of recommended future spending values.

4. The method of claim 3, further including:
if the at least one financial indicator value does not satisfy the desired financial rating, or the expected shareholder return is not maximized within the first set of constraints, then adjusting at least one of the predicted values associated with a spending category, to provide an adjusted set of predicted values; and
repeating steps (c) through (h) using the adjusted set of predicted values.

5. The method of claim 3, wherein the expected shareholder return is determined based on dividend yield and change in stock price for at least the portion of the business cycle.

6. The method of claim 1, wherein the at least two spending categories are selected from the group comprising: share repurchase spending, dividend payments, dividend growth, pension payments, VEBA payments, and investment and acquisition spending.

7. The method of claim 6, wherein the financial categories further include at least one of: sales and revenue, profit after tax, depreciation and amortization, undistributed earnings from financial products, cash flow from operations, capital expenditures, net free cash flow, common stock issued, dividend yield, dividend payout ratio, long term debt paid, long term debt issued, net short term borrowings, change in cash, long term debt outstanding, short term debt outstanding, and ending cash balance.

8. The method of claim 1, wherein the at least one financial indicator value includes at least one of: a finds from operations (FFO) to adjusted debt ratio; a debt to capital ratio; an adjusted debt to capital ratio; a free cash flow to debt ratio; and a debt to earnings before interest, taxes, depreciation, and amortization ratio.

9. The method of claim 1, wherein the first set of constraints includes at least one of: dividend growth remaining positive for the business cycle; cash balance remaining within a predetermined range for each period of the business cycle; minimum share repurchase for each period of the business cycle; minimum number of shares outstanding in a particular period; minimum pension contributions for at least a portion of the business cycle; dividend payout ratio remaining within predetermined parameters for a number of periods; and dividend yield remaining within a predetermined range for at least a portion of the business cycle.

10. The method of claim 1, wherein step (c) further includes calculating a plurality of financial indicator values for each period of the business cycle and determining an expected financial rating for each of the financial indicator values, and wherein the plurality of financial indicator values satisfy at least one desired rating if:
at least 60% of the plurality of financial indicator values in each period of the business cycle achieve a particular expected rating; and
at least 80% of the plurality of financial indicator values over a number of periods of the business cycle achieve a particular expected rating.

11. The method of claim 1, further including:
providing one or more additional sets of predicted values for each of the plurality of financial categories for at least the portion of the business cycle;
performing steps (b)-(e) for each of the additional sets of predicted values, thereby providing one or more additional sets of recommended future spending values;
analyzing the first set of recommended future spending values and at least one of the additional sets of recommended future spending values to determine an optimum set of future spending values; and
providing the optimum set of future spending values as a recommended set of future spending values.

12. The method of claim 11, wherein the analyzing further includes comparing probabilities and risk factors associated with each set of predicted values to determine the optimum set of recommended future spending values.

13. The method of claim 11, wherein the sets of predicted values reflect a plurality of respective scenarios including at least a time span of economic growth and a time span of economic recession.

14. A computer system for providing a recommendation for a business entity, comprising:
a storage for storing data reflecting a first set of predicted values including predicted values for each of a plurality of financial categories for at least a portion of a business cycle, wherein the categories comprise at least two spending categories, and wherein the predicted values for the at least two spending categories satisfy a first set of constraints;
a module for calculating at least one financial indicator value associated with at least one period of the business cycle, based on at least one of the predicted values from the first set of predicted values;
a module for calculating an expected shareholder return for at least a portion of the business cycle, based on at least one of the predicted values from the first set of predicted values;
a module for determining whether the at least one financial indicator value satisfies at least one desired financial rating;
a module for providing at least one of the predicted spending values as a recommended future spending value, if the at least one financial indicator value satisfies the desired financial rating and the expected shareholder return is maximized.

15. The computer system of claim 14, wherein the storage further stores additional sets of predicted values for each of the plurality of financial categories for at least the portion of the business cycle, and further comprising:
a module for providing at least one of the predicted values from at least one of the additional sets of predicted values as at least one additional set of recommended future spending values; and
a display for displaying the sets of recommended future spending values.

16. The computer system of claim 14, wherein the storage further stores data reflecting the at least two spending categories, and wherein the at least two spending categories include at least two of the following categories: share repurchase spending, dividend payments, dividend growth, pension payments, VEBA payments, and investment and acquisition spending.

17. The computer system of claim 14, wherein the storage further stores data reflecting the at least one financial indicator value, and wherein the at least one financial indicator value includes at least one of: a finds from operations (FFO) to adjusted debt ratio; a debt to capital ratio; an adjusted debt to capital ratio; a free cash flow to debt ratio; and a debt to earnings before interest, taxes, depreciation, and amortization ratio.

18. The computer system of claim 14, wherein the storage further stores data reflecting the first set of constraints, and wherein the first set of constraints includes at least one of: dividend growth remaining positive for the business cycle; cash balance remaining within a predetermined range for each period of the business cycle; minimum share repurchase for each period of the business cycle; minimum number of shares outstanding in a particular period; minimum pension contributions for at least a portion of the business cycle; dividend payout ratio remaining within predetermined parameters for a number of periods; and dividend yield remaining within a predetermined range for at least a portion of the business cycle.

19. A method of providing a financial recommendation for a business entity, comprising:
providing predicted values for each of a plurality of financial categories for each period of a business cycle, the plurality of financial categories comprising at least two spending categories, thereby creating a first set of predicted values reflecting a first scenario;
providing one or more additional sets of predicted values for the plurality of financial categories for each period of the business cycle, the one or more additional sets reflecting one or more respective additional scenarios;
based on at least part of the first set of predicted values, providing predicted spending values from the first set of predicted values as a first set of recommended future spending values;
based on at least part of the one or more additional sets of predicted values, providing predicted spending values from one or more of the additional sets of predicted values as one or more additional sets of recommended future spending values;
based on at least the probability of the first scenario, the probabilities of the one or more additional scenarios, the first set of recommended future spending values, and the one or more additional sets of recommended future spending values, determining an optimum set of future spending values; and
providing the optimum set of future spending values as a recommended set of future spending values.

20. The method of claim 19, further including comparing probabilities and risk factors associated with each set of predicted values to determine the optimum set of future spending values.

21. The method of claim 19, wherein the sets of predicted values reflect a plurality of respective scenarios including at least a time span of economic growth and a time span of economic recession.

22. The method of claim 19, further including:
for each scenario:
providing a first set of constraints for a first set of financial categories of the plurality of financial categories, and providing predicted values that satisfy the first set of constraints;
based on at least one of the predicted values, calculating at least one financial indicator value associated with at least one period of the business cycle;
based on at least one of the predicted values, calculating an expected shareholder return for at least a portion of the business cycle;
determining whether the at least one financial indicator value satisfies at least one desired financial rating;
determining whether the expected shareholder return for the predicted values for at least the portion of the business cycle is maximized within the first set of constraints; and
if the at least one financial indicator value satisfies the at least one desired financial rating and the expected shareholder return is maximized within the first set of constraints, then providing at least one of the predicted spending values as the set of recommended future spending values.
